(19) United States
(12) Patent Application Publication
(10) Pub. No.: US 2019/0064959 A1
(43) Pub. Date: Feb. 28, 2019

(54) FLEXIBLE TOUCH SCREEN AND MANUFACTURING METHOD THEREOF, FLEXIBLE DISPLAY DEVICE

(71) Applicant: BOE TECHNOLOGY GROUP CO., LTD., Beijing (CN)

(72) Inventor: Meizhu ZHENG, Beijing (CN)

(21) Appl. No.: 15/923,249

(22) Filed: Mar. 16, 2018

(30) Foreign Application Priority Data
Aug. 30, 2017 (CN) 201710766144.1

(51) Int. Cl. G06F 3/044

(52) U.S. Cl. CPC G06F 3/044; G06F 2203/04111; G06F 2203/04103; G06F 2203/04102

(57) ABSTRACT

A flexible touch screen includes a substrate, first electrode and second electrode disposed on the substrate, wherein the first electrode is provided connectedly, and the second electrode is separated by the first electrode into a first portion and a second portion which do not contact each other; an insulation layer disposed over the second electrode, the first portion and the second portion; and a bridging conductive layer disposed over the insulation layer and electrically connected to the first portion and the second portion, respectively, wherein an angle between a projection of the bridging conductive layer on the insulating layer and an edge of the insulation layer contacting the bridging conductive layer is other than 90 degrees.

### CROSS REFERENCE TO RELATED APPLICATIONS

This application claims the benefit of China Patent Application No. 201710766144.1 and titled “FLEXIBLE TOUCH SCREEN AND MANUFACTURING METHOD THEREOF, FLEXIBLE DISPLAY DEVICE” filed with the China Patent Office on Aug. 30, 2017, the entire content of which is hereby incorporated by reference.

### TECHNICAL FIELD

The disclosure relates to the technical field of touch screen, and in particular, to a flexible touch screen, a manufacturing method thereof and a flexible display device.

### BACKGROUND

Flexible touch screens have now found wide application. In a flexible touch screen, contact condition of electrodes is critical for the touch performance. However, in the related art, the intersection of the metal bridge and the insulation edge may be easily broken during the bending process of the touch screen, adversely affecting the touch performance.

At present, there is an urgent need to solve the problem that the intersection of the metal bridge and the insulation edge may be easily broken during the bending process of the touch screen.

### SUMMARY

The present disclosure provides a flexible touch screen, including:

a substrate; a first electrode and a second electrode disposed on the substrate, wherein the first electrode is provided connectedly, and the second electrode is separated by the first electrode into a first portion and a second portion which do not contact each other; an insulation layer disposed over the second electrode, the first portion, and the second portion; and a bridging conductive layer disposed over the insulation layer and electrically connected to the first portion and the second portion, respectively; wherein an angle between a projection of the bridging conductive layer on the insulating layer and an edge of the insulation layer contacting the bridging conductive layer is other than 90 degrees.

In an exemplary embodiment, an outline of the edge of the insulation layer is circular.

In an exemplary embodiment, the bridging conductive layer includes a conductive bridge, and a projection of the conductive bridge on the insulation layer is a curved line.

In an exemplary embodiment, the bridging conductive layer includes two conductive bridges, projections of the two conductive bridges on the insulation layer are curved lines respectively, and the two conductive bridges are separated from each other.

In an exemplary embodiment, the two conductive bridges are connected to each other at an intersection point.

In an exemplary embodiment, the conductive bridge is in an arc shape.

In an exemplary embodiment, the first electrode is a sensing electrode and the second electrode is a driving electrode, or the first electrode is a driving electrode and the second electrode is a sensing electrode.

In an exemplary embodiment, the material of the first electrode and the second electrode is indium tin oxide.

The present disclosure also provides a method for manufacturing a flexible touch screen, including: providing a substrate; forming a flexible conductive layer on the substrate; patterning the flexible conductive layer to form first electrode and second electrode, such that the first electrode is provided connectedly, and the second electrode is separated by the first electrode into a first portion and a second portion which do not contact each other; forming an insulation layer over the second electrode, the first portion and the second portion; forming a bridging conductive layer over the insulation layer, wherein an angle between a projection of the bridging conductive layer on the insulating layer and an edge of the insulation layer contacting the bridging conductive layer is other than 90 degrees.

In an exemplary embodiment, the bridging conductive layer includes a conductive bridge, and a projection of the conductive bridge on the insulation layer is a curved line.

In an exemplary embodiment, the material of the flexible conductive layer is indium tin oxide.

The present disclosure also provides a flexible display device includes the flexible touch screen of the above.

### BRIEF DESCRIPTION OF THE DRAWINGS

FIG. 1 is a structural diagram illustrating a flexible touch screen according to the related art.

FIG. 2 is a schematic top view illustrating a flexible touch screen according to an embodiment of the present disclosure.

FIG. 3 is a schematic side view illustrating a flexible touch screen according to an embodiment of the present disclosure.

FIG. 4 is a top schematic view illustrating a flexible touch screen according to another embodiment of the present disclosure.

FIG. 5 is a schematic top view illustrating a flexible touch screen according to still another embodiment of the present disclosure.

FIG. 6 is a schematic top view illustrating another flexible touch screen according to still another embodiment of the present disclosure.

FIG. 7 is a schematic top view illustrating still another flexible touch screen according to still another embodiment of the present disclosure.

### DETAILED DESCRIPTION

The disclosure is further described below in detail with reference to the accompanying drawings and embodiments. It should be understood that the specific embodiments described herein are only used for explaining the disclosure rather than limiting the disclosure. In addition, it should also be noted that, for the convenience of description, only some but not all structures related to the present disclosure are shown in the accompanying drawings.

A bridge structure of a touch screen is disclosed in the related art, and includes a substrate on which a plated conductive layer and a plurality of bridge point areas are disposed. The bridge point areas are arranged. The plated conductive layer is disposed between adjacent bridge point areas. The bridge point area covers a bridge-point insulation protection layer, and at least two linear metal bridges in parallel are arranged above the bridge point area.

As shown in FIG. 1, another technology also discloses a flexible touch screen, including a transparent flexible substrate, and a transparent conductive film layer disposed on the transparent flexible substrate. The transparent conductive film layer includes a plurality of first electrode 102 and a plurality of second electrode 101 which are formed by means of laser etching (the first electrode and the second electrode refer to the driving electrodes and the sensing electrodes), in which the plurality of first electrode and the plurality of second electrode intersect with each other to form a touch sensing pattern. The first electrode 102 is provided connectedly, and the second electrode 101 is separated by the first electrode to form touch units not in communication with each other. A transparent insulation polymer film layer 103 formed by printing is disposed on the second electrode at the separation position. A bridging conductive portion 104 is disposed on the transparent insulation polymer film layer, for conducting the second electrode 101 and forming a bridging structure as shown in FIG. 1. However, the bridging structure is very easily broken at the position 106 and does not have mass productivity for the flexible product, so it is an extremely high risk for the mass production.

In order to solve the problem that the intersection of the metal bridge and the insulation edge is easily broken during the bending process of the touch screen, the present disclosure proposes the following embodiments.

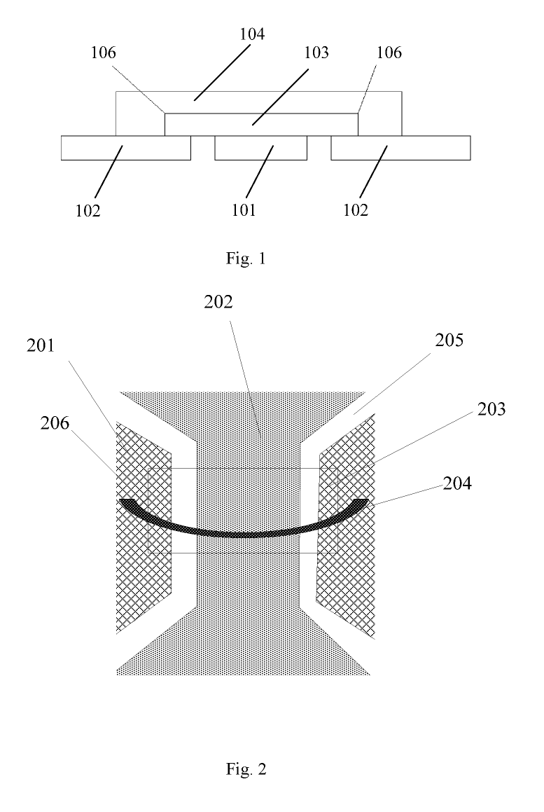

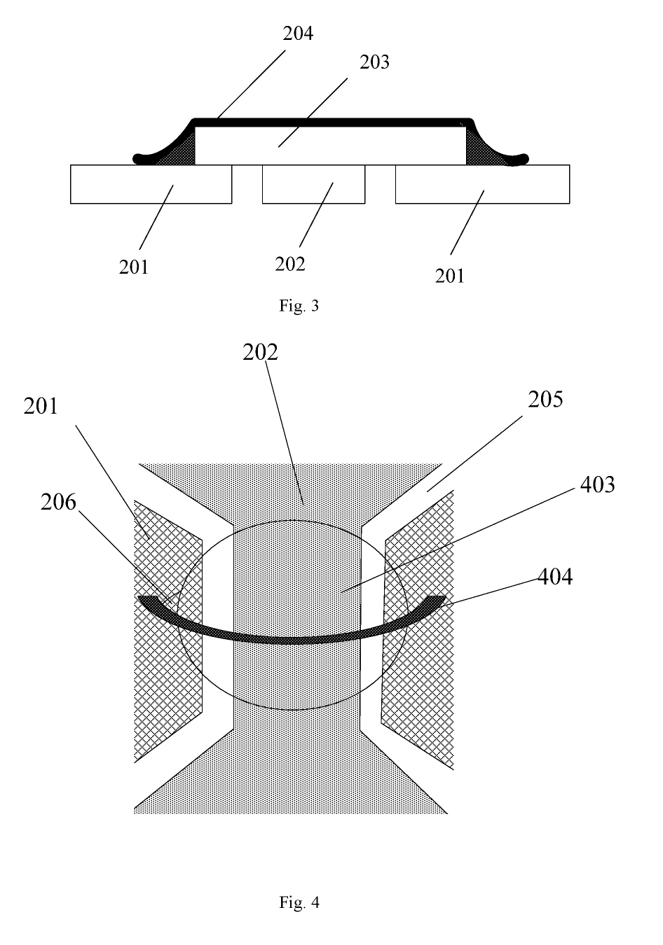

An embodiment of the present disclosure provides a flexible touch screen, and a schematic plan view of the touch screen is shown in FIG. 2.

The flexible touch screen according to the present embodiment includes: a substrate (not shown); a first electrode 202 and a second electrode 201 disposed on the substrate with a space 205 between the first electrode 202 and the second electrode 201, wherein the first electrode 202 is provided connectedly, and the second electrode 201 is separated by the first electrode 202 into a first portion and a second portion which do not contact each other; an insulating layer 203, disposed over the first electrode 202 and the second electrode 201; and a bridging conductive layer 204 disposed over the insulation layer and electrically connected to the first portion and the second portion respectively; wherein an angle 206 between the projection of the bridging conductive layer on the insulating layer and an edge of the insulation layer contacting the bridging conductive layer is other than 90 degrees.

Here, the first electrode is a sensing electrode and the second electrode is a driving electrode, or the first electrode is a driving electrode and the second electrode is a sensing electrode. The material of the first electrode and the second electrode is indium tin oxide.

The bridging conductive layer 204 provided herein is composed of a flexible metal having good conductivity and electrically connects the first portion and the second portion of the second electrode 201. In addition, the bridging conductive layer 204 has an arc shape. As can be seen from the top view, the angle between the projection of the bridging conductive layer 204 on the insulation layer 203 and the edge of the insulation layer contacting the bridging conductive layer is other than 90 degrees. In this way, there is a buffer space against stress at the intersection of the bridging conductive layer and the edge of the insulation layer 203, so that the breakage does not occur easily.

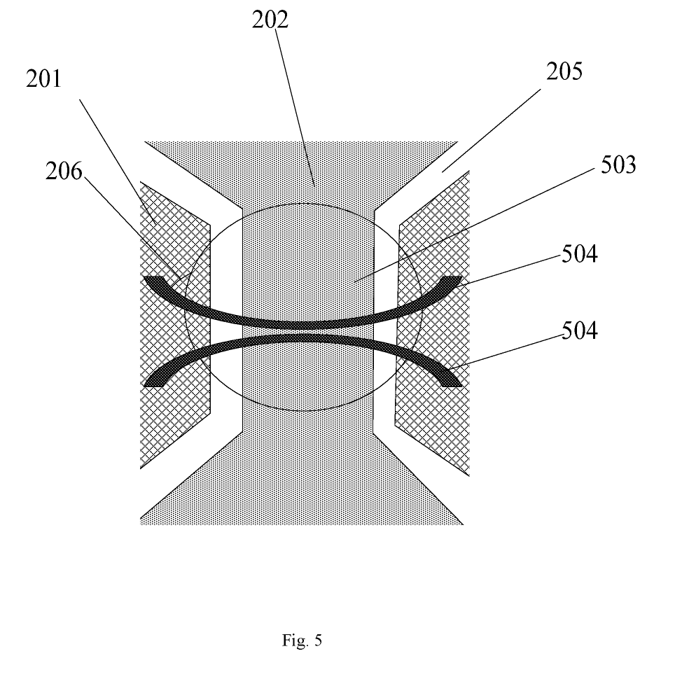

A schematic side view of the touch screen according to the present embodiment is shown in FIG. 3. The arc-shaped design of the bridging conductive layer 204 allows the bridging conductive layer and the insulation layer 203 to contact in a moderate arc degree, in contrast to the vertical step-shape of the bridge in the related art, so that the breakage does not occur easily when the product is bent. Moreover, the second electrode can be electrically connected with high efficiency and high quality.

According to the flexible touch panel of the present embodiment, the arc-shaped design of the bridging conductive layer is adopted so that the intersection of the bridging conductive layer and the insulation layer will not be easily broken and the bending resistance of the product can be improved.

Another embodiment of the present disclosure provides a flexible touch screen, and a schematic top view of the touch screen is shown in FIG. 4.

The flexible touch screen according to the present embodiment includes a substrate (not shown in the figure), a first electrode 202 and a second electrode 201 disposed on the substrate, wherein the first electrode 202 is provided connectedly, and the second electrode 201 is separated by the first electrode 202 into a first portion and a second portion which do not contact each other; an insulation layer 403 disposed over the first electrode 202 and the second electrode 201; a bridging conductive layer 404 disposed over the insulation layer and electrically connected to the first portion and the second portion respectively; wherein an angle between the projection of the bridging conductive layer on the insulating layer and an edge of the insulation layer contacting the bridging conductive layer is other than 90 degrees.

This embodiment differs from the first embodiment in that the outline of the edge of the insulation layer is circular.

With such design, the contact angle between the circular insulation layer and the arc-shaped bridging conductive layer 404 may be more moderate, so that there is a more sufficient buffer space against stress at the intersection of the bridging conductive layer and the edge of the insulation layer 403. The product is not easily broken, and it can further improve the bending resistance.

According to the flexible touch panel of this embodiment, the arc design of the bridging conductive layer is combined with the circular design of the insulation layer to make the intersection of the bridging conductive layer and the insulation layer less likely to be broken, thereby further improving the bending resistance of the product.

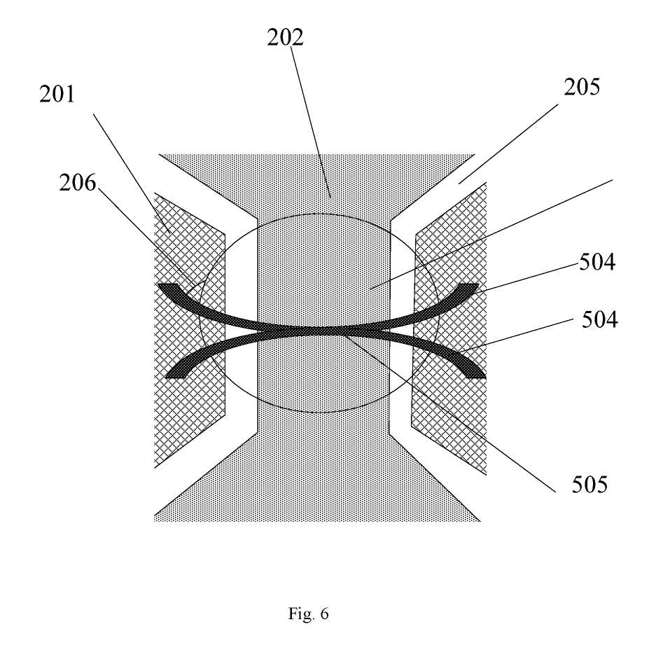

Yet another embodiment of the present disclosure provides a flexible touch screen, which is shown as a schematic top view of FIG. 5.

The flexible touch screen according to the present embodiment includes: a substrate (not shown); a first electrode 202 and second electrode 201 disposed on the substrate wherein the first electrode 202 is provided connectedly, and the second electrode 201 is separated by the first electrode 202 into a first portion and a second portion which do not contact each other; an insulating layer 203, disposed over the first electrode 202 and the second electrode 201; and a bridging conductive layer 204 disposed over the insulation layer and electrically connected to the first portion and the second portion respectively; wherein an angle 206 between the projection of the bridging conductive layer on the insulating layer and an edge of the insulation layer contacting the bridging conductive layer is other than 90 degrees.

This embodiment differs from the second embodiment in that the bridging conductive layer includes two conductive bridges 504, and the projections of the two conductive bridges on the insulation layer are curved lines respectively, and the two conductive bridges are separated from each other.

The design of the two conductive bridges can not only improve the bending resistance of the product, but can also improve the conductivity between the two portions of the second electrode and can improve the yield of the product.

FIG. 6 shows that in another embodiment, the two conductive bridges 504 may be connected to each other at an intersection point 505. The advantage lies in that the conductivity can be further improved.

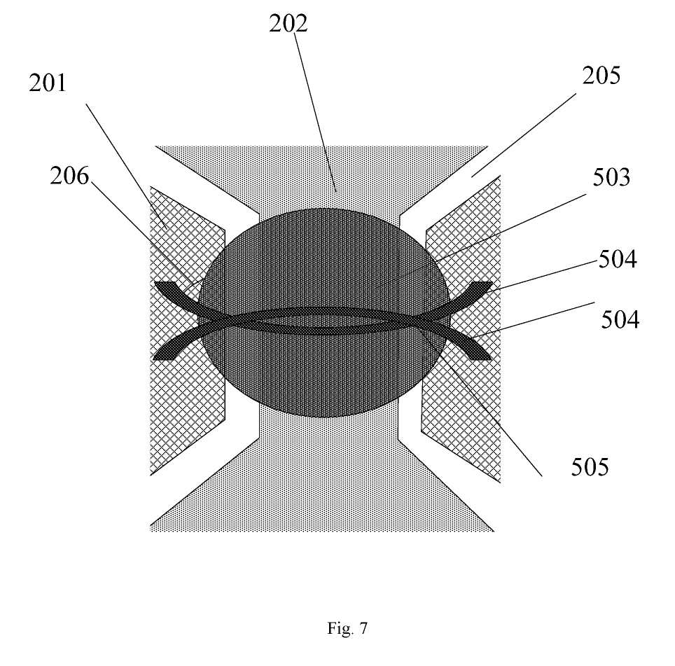

FIG. 7 shows that in a further embodiment, two conductive bridges 504 may be connected to each other with two intersection points 505. The advantage lies in that the conductivity can be further improved.

In yet another embodiment of the present disclosure, a method for manufacturing a flexible touch screen is provided for manufacturing a flexible touch screen as described in the previous embodiments.

The method for manufacturing the flexible touch panel includes the following steps. First a substrate is provided. Then, a flexible conductive layer is formed on the substrate, and the flexible conductive layer is usually made of material of indium tin oxide. After that, the flexible conductive layer is subject to patterning process such as etching to form the first electrode and the second electrode at one time. The first electrode is provided connectedly, and the second electrode is separated by the first electrode into a first portion and a second portion which do not contact each other. An insulating layer is formed over the first electrode, the first portion and the second portion. An arc-shaped bridging conductive layer is formed over the insulation layer, wherein an angle between the projection of the bridging conductive layer on the insulating layer and an edge of the insulation layer contacting the bridging conductive layer is other than 90 degrees.

Another embodiment of the present disclosure provides a flexible display device, which includes the flexible touch screen as described above.

It should be understood by those skilled in the art that the present disclosure is not limited to the specific embodiments described herein, and various obvious variations, modifications and substitutions can be made by those skilled in the art without departing from the scope of the disclosure. Therefore, although the present disclosure has been described in detail through the above embodiments, the present disclosure is not limited to the above embodiments, and more other equivalent embodiments may be included without departing from the concept of the present disclosure, while the scope of the present disclosure is determined by the appended claims.

What is claimed is:

1. A flexible touch screen, comprising:
a substrate;
a first electrode and a second electrode disposed on the substrate, wherein the first electrode is provided connectedly, and the second electrode is separated by the first electrode into a first portion and a second portion, wherein the first and second portions do not contact each other;
an insulation layer disposed over the second electrode, the first portion, and the second portion; and
a bridging conductive layer disposed over the insulation layer and electrically connected to the first portion and the second portion, respectively; wherein an angle between a projection of the bridging conductive layer on the insulating layer and an edge of the insulation layer contacting the bridging conductive layer is other than 90 degrees.

2. The flexible touch screen of claim 1, wherein an outline of the edge of the insulation layer is circular.

3. The flexible touch screen of claim 1, wherein the bridging conductive layer comprises a conductive bridge, and a projection of the conductive bridge on the insulation layer is a curved line.

4. The flexible touch screen of claim 3, wherein the bridging conductive layer comprises two conductive bridges, projections of the two conductive bridges on the insulation layer are curved lines, and the two conductive bridges are separated from each other.

5. The flexible touch screen of claim 1, wherein the two conductive bridges are connected to each other at an intersection point.

6. The flexible touch screen of claim 3, wherein the conductive bridge is in an arc shape.

7. The flexible touch screen of claim 4, wherein the conductive bridge is in an arc shape.

8. The flexible touch screen of claim 5, wherein the conductive bridge is in an arc shape.

9. The flexible touch screen of claim 1, wherein the first electrode is a sensing electrode and the second electrode is a driving electrode, or the first electrode is driving electrodes and the second electrode is a sensing electrode.

10. The flexible touch screen of claim 2, wherein the first electrode is a sensing electrode and the second electrode is a driving electrode, or the first electrode is a driving electrode and the second electrode is a sensing electrode.

11. The flexible touch screen of claim 3, wherein the first electrode is a sensing electrode and the second electrode is a driving electrode, or the first electrode is a driving electrode and the second electrode is a sensing electrode.

12. The flexible touch screen of claim 1, wherein the material of the first electrode and the second electrode is indium tin oxide.

13. The flexible touch screen of claim 2, wherein the material of the first electrode and the second electrode is indium tin oxide.

14. The flexible touch screen of claim 3, wherein the material of the first electrode and the second electrode is indium tin oxide.

15. A method for manufacturing a flexible touch screen, comprising:
providing a substrate;
forming a flexible conductive layer on the substrate;
patterning the flexible conductive layer to form a first electrode and a second electrode, such that the first electrode is provided connectedly, and the second electrode is separated by the first electrode into a first portion and a second portion, wherein the first and second portions do not contact each other;
forming an insulation layer over the second electrode, the first portion and the second portion;
forming a bridging conductive layer over the insulation layer, wherein an angle between a projection of the bridging conductive layer on the insulating layer and an edge of the insulation layer contacting the bridging conductive layer is other than 90 degrees.

16. The method for manufacturing a flexible touch screen of claim 15, wherein the bridging conductive layer comprises a conductive bridge, and a projection of the conductive bridge on the insulation layer is a curved line.

17. The method for manufacturing a flexible touch screen according to claim 15, wherein the material of the flexible conductive layer is indium tin oxide.

18. A flexible display device includes the flexible touch screen of claim 1.

19. The flexible display device of claim 18, wherein an outline of the edge of the insulation layer is circular.

20. The flexible display device of claim 18, wherein the bridging conductive layer comprises a conductive bridge, and a projection of the conductive bridge on the insulation layer is a curved line.
